(19) United States
(12) Patent Application Publication
(10) Pub. No.: US 2012/0066083 A1
(43) Pub. Date: Mar. 15, 2012

(54) INFORMATION PROCESSING APPARATUS, IMAGE PROCESSING APPARATUS MANAGING SYSTEM, AND METHOD OF PROCESSING INFORMATION

(75) Inventors: Eijiro INOUE, Kanagawa (JP); Akinori Itoh, Kanagawa (JP)

(73) Assignee: RICOH COMPANY, LTD., Tokyo (JP)

(21) Appl. No.: 13/213,556

(22) Filed: Aug. 19, 2011

(30) Foreign Application Priority Data
Sep. 14, 2010 (JP) 2010-205932

(51) Int. Cl. G06Q 30/00; G06F 9/445

(52) U.S. Cl. 705/26.1; 717/178

(57) ABSTRACT

An information processing apparatus is provided with an image processing apparatus managing unit that collects management information of a plurality of image processing apparatuses and, in accordance with a request for installing software that is transmitted from the outside, downloads the software to be installed to the image processing apparatus from the outside, acquires license information of the software from the outside, and installs the software to the image processing apparatus. The image processing apparatus managing unit installs cooperation software to an optimal image processing apparatus on the basis of the collected management information in a case where the software requested to be installed is the cooperation software that operates the plurality of image processing apparatuses in a cooperative manner.

### CROSS-REFERENCE TO RELATED APPLICATIONS

The present application claims priority to and incorporates by reference the entire contents of Japanese Patent Application No. 2010-205932 filed in Japan on Sep. 14, 2010.

### BACKGROUND OF THE INVENTION

1. Field of the Invention

The present invention relates to an information processing apparatus, an image processing apparatus managing system, a method of processing information, and a program thereof.

2. Description of the Related Art

Conventionally, a technology is known in which, by installing software (cooperation software) that causes image processing apparatuses such as a plurality of image forming apparatuses interconnected through a network to work together to serve as a virtual apparatus, the plurality of image processing apparatuses operate like a virtual apparatus that can implement a specific function. For example, Japanese Patent Application Laid-open No. 2009-093228 discloses an image forming apparatus managing system that aims at providing a supervisor of image forming apparatuses with means for building a virtual apparatus with high efficiency. In the system, a management server of the image forming apparatuses determines whether or not software can be installed on each image forming apparatus on the basis of the hardware configuration of the image forming apparatus, and presents an image forming apparatus that can serve as a constituent element of the virtual apparatus to the supervisor, on the basis of the result of the determination.

However, in the conventional image forming apparatus managing system as described above, a criterion for selecting image forming apparatuses to constitute the virtual apparatus is based on the hardware configurations of the image forming apparatuses, but the use status and the operating method of each image forming apparatus are not considered. For such a reason, it was difficult to build an optimized virtual apparatus adapted to the environment of a customer.

### SUMMARY OF THE INVENTION

It is an object of the present invention to at least partially solve the problems in the conventional technology.

According to an aspect of the present invention, there is provided an information processing apparatus that includes: an image processing apparatus managing unit that collects management information of a plurality of image processing apparatuses and, in accordance with a request for installing software that is transmitted from the outside, downloads the software to be installed to the image processing apparatus from the outside, acquires license information of the software from the outside, and installs the software to the image processing apparatus. The image processing apparatus managing unit installs cooperation software to an optimal image processing apparatus on the basis of the collected management information in a case where the software requested to be installed is the cooperation software that operates the plurality of image processing apparatuses in a cooperative manner.

According to an aspect of the present invention, there is provided an image processing apparatus managing system that includes: a software selling unit that accepts a user's purchase of software and transmits purchase information that includes information on the purchased software and information on a user site of the user purchasing the software; a user site managing unit that manages image processing apparatuses located on the user site side, receives the purchase information from the software selling unit, and performs a request for installing the purchased software on the user site side on the basis of the purchase information; a software providing unit that provides the purchased software; a license providing unit that provides license information of the purchased software; a plurality of image processing apparatuses; and an image processing apparatus managing unit that collects management information of the plurality of image processing apparatuses, in response to the request for installing the software that is transmitted from the user site managing unit, downloads the purchased software from the software providing unit, acquires the license information of the software from the license providing unit, and installs the acquired software to the image processing apparatus. The image processing apparatus managing unit installs cooperation software to an optimal image processing apparatus on the basis of the collected management information in a case where the software requested to be installed is the cooperation software that operates the plurality of image processing apparatuses in a cooperative manner.

According to an aspect of the present invention, there is provided a method of processing information using information processing apparatuses. The method includes: collecting management information of a plurality of image processing apparatuses and, in accordance with a request for installing software that is transmitted from the outside, downloading the software to be installed to the image processing apparatus from the outside, acquiring license information of the software from the outside, and installing the software to the image processing apparatus, using an image processing apparatus managing unit. In the collecting of management information, downloading of the software, acquiring of license information, and installing of the software, cooperation software is installed to an optimal image processing apparatus on the basis of the collected management information in a case where the software requested to be installed is the cooperation software that operates the plurality of image processing apparatuses in a cooperative manner.

Herein, the term “a cooperative manner” means that the plurality of image processing apparatuses operate in association with each other via network, so that a virtual apparatus can be established.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating the entire configuration of an image forming apparatus managing system according to an embodiment of the invention;

FIG. 2 is a diagram illustrating an example of the hardware configuration of a relay apparatus;

FIG. 3 is a diagram illustrating an example of the hardware configuration of a management apparatus;

FIG. 4 is a diagram illustrating an example of the hardware configuration of a component server;

FIG. 5 is a diagram illustrating an example of the hardware configuration of an activation server;

FIG. 6 is a diagram illustrating a process of collecting management information of an image forming apparatus in the relay apparatus;

FIG. 7 is a diagram illustrating an example of a table representing a list of apparatus IDs and counter information;

FIGS. 8A and 8B are diagrams illustrating a series of operations that are performed in each apparatus of the image forming apparatus managing system;

FIG. 9 is a diagram illustrating an example of a table in which a function of an application (software) maintained by a selling system portal, a software ID, and information indicating whether or not the software is cooperation software are associated with one another;

FIG. 10 is a diagram illustrating an example of a table in which failure history information is stored;

FIG. 11 is a diagram illustrating an example of a table in which software set values are stored;

FIG. 12 is a diagram illustrating an example of a table in which apparatus statuses are stored;

FIG. 13 is a diagram illustrating a series of operations that are performed when software is reinstalled;

FIG. 14 is a diagram illustrating an example of a table in which apparatus statuses including information of component replacement time are stored; and

FIG. 15 is a diagram illustrating an example of a table in which apparatus statuses including information of replacement time of supplies are stored.

### DETAILED DESCRIPTION OF THE PREFERRED EMBODIMENTS

Hereinafter, an image forming apparatus managing system according to an embodiment of the invention will be described in detail with reference to the accompanying drawings.

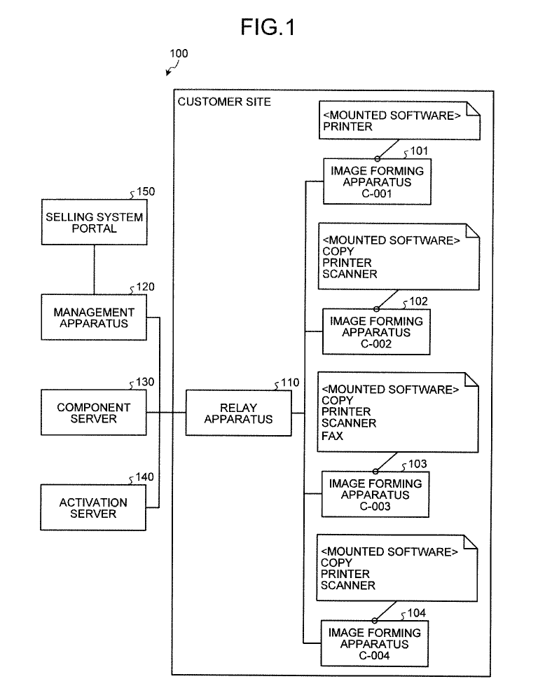

First, the entire configuration of an image forming apparatus managing system according to the embodiment of the invention will be described with reference to FIG. 1. FIG. 1 is a block diagram illustrating the entire configuration of the image forming apparatus managing system according to the embodiment of the invention.

An image forming apparatus managing system 100 according to this embodiment is configured by: image forming apparatuses (for example, MFPs that respectively include at least two functions out of a copying function, a printer function, a scanner function, and a facsimile function or the like) 101, 102, 103, and 104 as a plurality of image processing apparatuses; a relay apparatus (information processing apparatus) 110 that is connected to a plurality of the image forming apparatuses 101 to 104 through a local network such as a LAN; a management apparatus (information processing apparatus) 120 that is connected to the relay apparatus 110 through a network such as the Internet; a component server 130; an activation server 140; and a selling system portal (server) 150 that is connected to the management apparatus 120 through a network. Here, the selling system portal 150 is a portal site that is used when a customer purchases software through the Internet. In addition, the image forming apparatuses 101 to 104 and the relay apparatus 110 are apparatuses that are disposed on a customer site (user site) side.

An overview of the flow of a process performed in the image forming apparatus managing system 100 is as follows.

First, when a customer purchases software, the selling system portal 150 transmits the purchase information to the management apparatus 120. In this purchase information, information on the purchased software (a software ID or the like) and information on a customer site that includes information (an address or the like) used for specifying the relay apparatus 110 are included. The management apparatus 120 that has received the software purchase information of a customer from the selling system portal 150 outputs a request for installing software to any of the image forming apparatuses 101 to 104 to the relay apparatus 110 on the basis of the purchase information.

The image forming apparatus managing system 100 according to this embodiment is featured in the process of the relay apparatus 110 that has received the request for installing software, and, in a case where the software requested to be installed from the management apparatus 120 is cooperation software that is used for building a “virtual apparatus” that realizes one function by cooperatively operating the plurality of image forming apparatuses, the image forming apparatus managing system 100 selects an optimal image forming apparatus that becomes an installation destination of the cooperation software on the basis of management information stored in the relay apparatus 110 (to be described later in detail).

Then, the relay apparatus 110 requests the component server 130 and the activation server 140 to download the cooperation software to be installed to each selected image forming apparatus and to issue a license key of the cooperation software and installs the downloaded cooperation software to each selected image forming apparatus by using the acquired license key.

As above, the relay apparatus 110 manages software installation of the image forming apparatuses 101 to 104 by transmitting or receiving signals to or from the management apparatus 120, the component server 130, and the activation server 140 through the network.

The main functions of the relay apparatus 110 includes a function of acquiring (downloading) software from the component server 130 in response to a request for installing the software from the management apparatus 120, a function of acquiring a license key of the software from the activation server 140, a function of additionally storing management information of the image forming apparatuses 101 to 104, which is collected by the management apparatus 120, inside the relay apparatus 110, and a function of managing the installation of software. In addition, as the function of managing the installation of software, the relay apparatus 110, in a case where a request for installing cooperation software is received from the management apparatus 120, determines an image forming apparatus that is optimal for the installation of the software on the basis of the management information of the image forming apparatuses 101 to 104 maintained therein, requests the image forming apparatus selected based on a result of the determination to install the cooperation software, and receives a reply thereto.

The management apparatus 120 includes a function of starting transmission and reception of various requests necessary for managing the image forming apparatuses, which are represented by a request for the installation of software to the image forming apparatus and receiving and collecting a notification of a counter value, a failure notification, and the like as the management information of the image forming apparatuses that are transmitted from the relay apparatus 110 by communicating with the selling system portal 150 of software and the relay apparatus 110 through a network. The management apparatus 120 is linked to the selling system portal 150 and transmits a request for installing software to the relay apparatus 110 on the basis of software purchase information of a customer that is notified from the selling system portal 150. As above, the management apparatus 120 includes a function of installing or uninstalling software according to the purpose of use of each one of the image forming apparatuses 101 to 104 through the relay apparatus 110 and controls the installation of purchased software to any of the image forming apparatuses 101 to 104 in accordance with customer's purchase of the software by using the selling system portal 150.

The component server 130 is an apparatus that receives a request for downloading software from the relay apparatus 110 and replies to the relay apparatus 110 with software of a software ID designated by the request. In addition, the activation server 140 is an apparatus that receives a request for issuing a license key from the relay apparatus 110, issues a license key corresponding to the software ID and an apparatus ID designated by the request, and replies to the request transmitted from the relay apparatus 110. The license key of the software that is downloaded from the component server 130 is assigned in accordance with the content of an agreement made in advance.

Although only one customer site is represented in FIG. 1 as an example, there may be a plurality of customer sites.

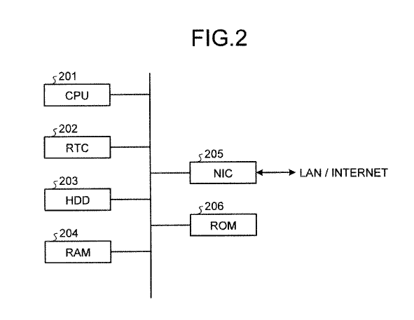

Subsequently, an example of the hardware configuration of each apparatus will be described with reference to FIGS. 2 to 5.

FIG. 2 is a diagram illustrating an example of the hardware configuration of the relay apparatus 110. The relay apparatus 110 is configured by a CPU 201, an RTC 202, a hard disk (HDD) 203, a RAM 204, a network interface card (NIC) 205, and a ROM 206. The RTC is an abbreviation of a real time clock and is an internal clock. The HDD 203 is a non-volatile storage medium, stores the management information collected from the image forming apparatuses 101 to 104, and maintains software purchased by an owner or a supervisor (hereinafter, referred to as a user) of the image forming apparatuses 101 to 104 and the license key thereof. In addition, in this HDD 203, a license key of software to be added or updated to any of the image forming apparatuses 101 to 104, which is provisionally issued in advance, may be maintained (the license key is used in accordance with the content of the agreement). Although the above-described management information may be regularly collected by using the RTC 202, it may be updated and collected when the software is installed.

The NIC 205 is an interface that is connected to the image forming apparatuses 101 to 104 through a local area network (LAN) and is further connected to the management apparatus 120, the component server 130, and the activation server 140 through the Internet. In addition, a WebUI of the relay apparatus 110 may be displayed through the NIC 205 in a customer engineer (CE) terminal (not shown in the drawings).

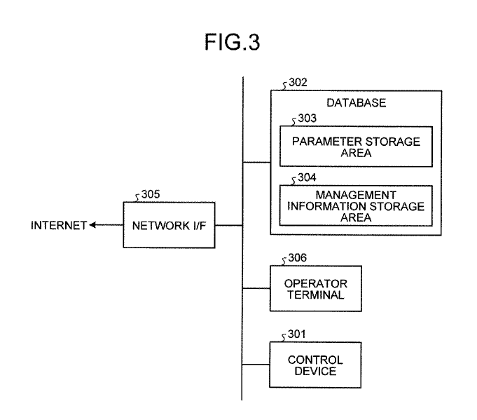

FIG. 3 is a diagram illustrating an example of the hardware configuration of the management apparatus 120. The management apparatus 120 is configured by a control device 301, a database 302, a network I/F 305, an operator terminal 306, and the like. The network I/F 305 is an I/F that controls communication with other devices connected through the network. The operator terminal 306 is used as an input interface of various kinds of data for an operator. The database 302 is configured by a parameter storage area 303 in which various parameters and a management program used for managing each image forming apparatus and data input by the operator are stored and a management information storage area 304 in which management information such as a counter value and the like of each image forming apparatus is stored. The control device 301 includes a CPU, a ROM, a RAM, and the like that are not shown in the drawings, performs overall control of the management apparatus 120 in accordance with a control program stored in the ROM and the RAM and realizes the function of receiving the management information such as a counter value.

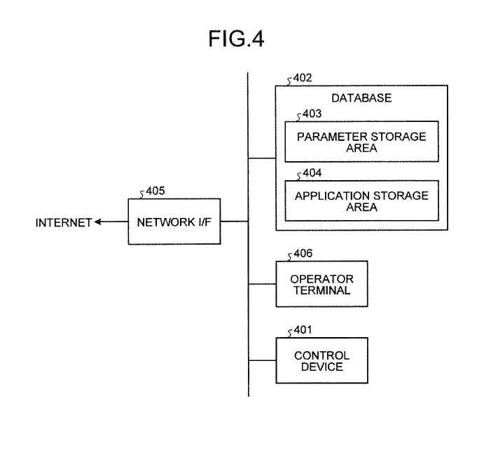

FIG. 4 is a diagram illustrating an example of the hardware configuration of the component server 130. The component server 130 is configured by a control device 401, a database 402, a network I/F 405, an operator terminal 406, and the like. The network I/F 405 is an interface (I/F) that controls communication with other devices connected through a network such as the Internet. The operator terminal 406 is used as an input interface for an operator managing various applications or the like. The database 402 is configured by a parameter storage area 403 in which various parameters used for managing an application (software) for each image forming apparatus, a management program, and data input by the operator are stored and an application storage area 404 in which a program main body of an application is stored. The control device 401 includes a CPU, a ROM, a RAM, and the like that are not shown in the drawings, performs overall control of the component server 130 in accordance with a control program stored in the ROM and the RAM, and realizes the function of receiving and replying to a request for downloading an application from each relay apparatus 110.

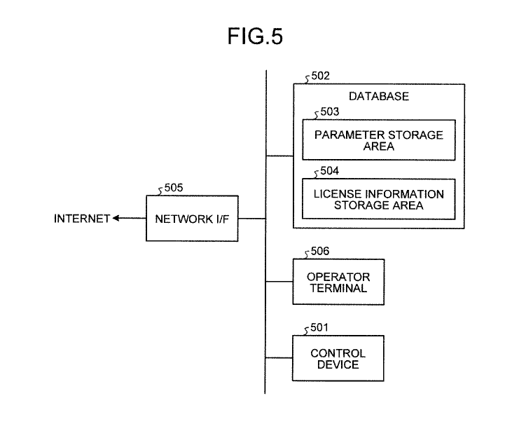

FIG. 5 is a diagram illustrating an example of the hardware configuration of the activation server 140. The activation server 140 is configured by a control device 501, a database 502, a network I/F 505, an operator terminal 506, and the like. The network I/F 505 is an I/F that controls communication with other devices connected through a network. The operator terminal 506 is used as an input interface for an operator managing licenses of various applications or the like. The database 502 is configured by a parameter storage area 503 in which various parameters used for managing licenses of applications of each image forming apparatus for each user, a management program, data input by the operator, the purchase information transmitted from the management apparatus 120 are stored and a license information storage area 504 in which license keys of purchased software are stored. The control device 501 includes a CPU, a ROM, a RAM, and the like that are not shown in the drawings, performs overall control of the activation server 140 in accordance with a control program stored in the ROM and the RAM, and realizes the function of receiving and replying to a request for issuing a license from each relay apparatus 110.

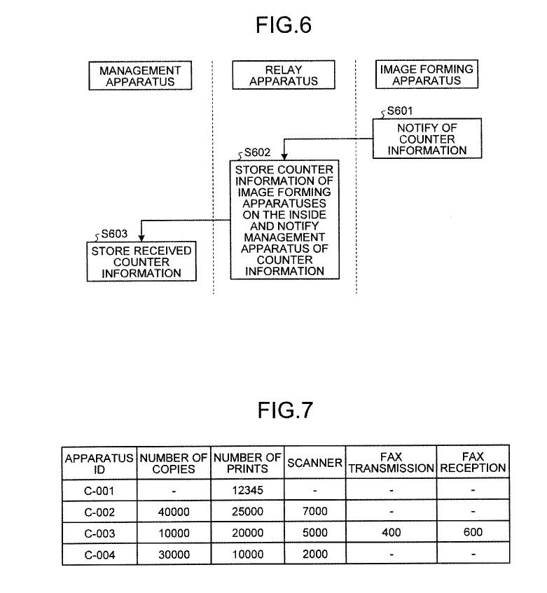

Next, a process of collecting the management information of each image forming apparatus, which is performed by the relay apparatus 110, will be described with reference to FIG. 6. FIG. 6 is a diagram illustrating the process of collecting the management information of an image forming apparatus in the relay apparatus 110.

When the management information transmitted from the image forming apparatus is received in Step S601, the relay apparatus 110 stores the information in the inside thereof (the HDD 203) and then notifies the management apparatus 120 of the same information in Step S602. For example, in a case where counter information (counter value) representing the use frequency of a specific function is handled as the management information of the image forming apparatus, the relay apparatus 110 maintains a list (table) of the apparatus ID and the counter information represented in the table illustrated in FIG. 7. Then, when the counter information is received from the image forming apparatus, the relay apparatus 110 updates the list information and then transmits the management information of the image forming apparatus to the management apparatus 120. The management apparatus 120 that has received the management information such as the counter information from the relay apparatus 110 stores the management information in the database 302 arranged inside thereof in Step S603.

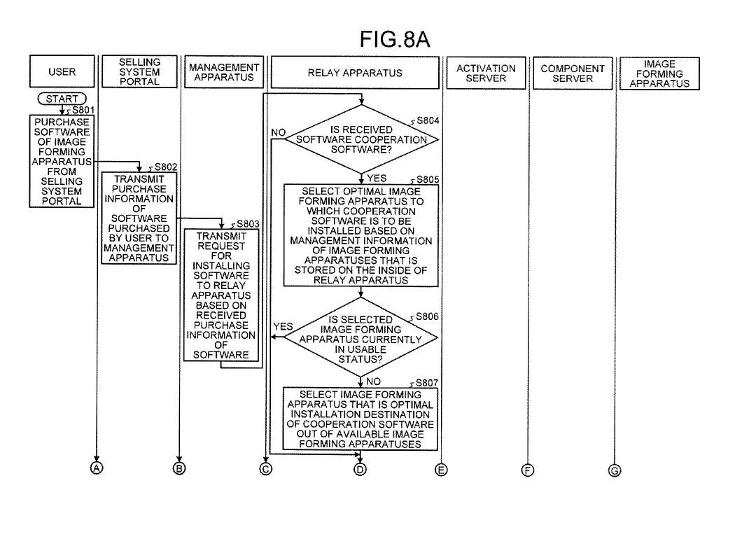

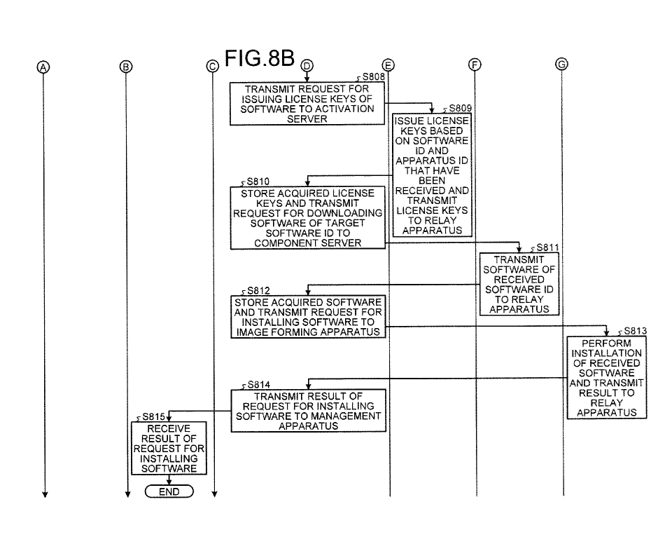

Subsequently, a series of operations performed in each apparatus of the image forming apparatus managing system 100 will be described with reference to FIGS. 8A and 8B. FIGS. 8A and 8B are diagrams illustrating a series of operations that are performed in each apparatus of the image forming apparatus managing system 100.

First, for purchasing software, a user using the image forming apparatuses 101 to 104 inputs a function desired to be used in any of the image forming apparatuses 101 to 104 and the apparatus ID of an image forming apparatus (any of the image forming apparatuses 101 to 104) as an installation target from the selling system portal 150. At this time, the user performs the input operation through a user terminal device (not shown in the drawing) that is connected to the selling system portal 150 through the Internet. The input information is transmitted from the user terminal device to the selling system portal 150, and the selling system portal 150 performs a process of accepting a software purchase. Accordingly, the software purchase made by the user is completed in Step S801.

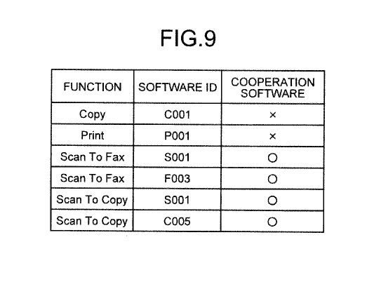

When the acceptance of the software purchase is completed by accepting the input from the user side, the selling system portal 150 transmits information used for determining whether the purchased software is cooperation software to the management apparatus 120 in addition to the apparatus ID of the image forming apparatus (any one of the image forming apparatuses 101 to 104) as an installation target and the ID of the purchased software as the purchase information of the software purchased by the user in Step S802. In addition, the selling system portal 150 maintains a table, as illustrated in FIG. 9 as an example, in which the function of the application (software), the software ID, and the information representing whether or not the software is cooperation software (in the figure, shown as “o” or “x”) are associated with one another.

First Example

Here, as one example, an example will be considered in which a user purchases software implementing a Scan-to-Fax (an image scanned by an image forming apparatus is faxed) function for the image forming apparatus 103 of the apparatus ID “C-003”. In such a case, the number of units of the cooperation software to be installed is two including cooperation software (software ID: S001) used for transmitting scanned image data to another image forming apparatus through a network and cooperation software (software ID: F003) used for performing fax transmission of the image data received through the network. In addition, since the two units of the software are cooperation software, the management apparatus 120 is notified that the target software is cooperation software in combination with the purchase information of the software.

Subsequently, the management apparatus 120 transmits a request for installing the cooperation software (software ID: S001) and the cooperation software (software ID: F003) for the image forming apparatus 103 to the relay apparatus 110 through the network on the basis of the software purchase information of the user that is received from the selling system portal 150 in Step S803.

In a case where the software requested to be installed is cooperation software (Yes in Step S804), the relay apparatus 110 that has received the request for installing the software determines an image forming apparatus for which the installation of the software is optimal on the basis of the management information of the image forming apparatuses 101 to 104 that is stored inside the relay apparatus 110 and selects the image forming apparatus in Step S805. In addition, in this example, it is assumed that counter information is stored inside the relay apparatus 110 as the management information of each image forming apparatus 101 to 104.

In the above-described example, installation of the cooperation software including software of “software ID: S001” and software of “software ID: F003” is requested, and it can be determined that there is only one image forming apparatus 103 of “apparatus ID: C-003” to which software of “software ID: F003” can be installed on the basis of the counter information. Thereby, the image forming apparatus 103 is selected as an installation destination of the software. On the other hand, it can be determined that the installation destination of the software “software ID: S001” can be selected from among three image forming apparatuses of “apparatus ID: C-002”, “apparatus ID: C-003”, and “apparatus ID: C004” on the basis of the counter information.

Here, the relay apparatus 110 selects an image forming apparatus as an installation destination by using a specific selection criterion on the basis of the management information of the image forming apparatuses 101 to 104 that is stored on the inside thereof. Here, as the specific selection criterion, a determination criterion of “installing cooperation software to an image forming apparatus that is the most frequently used” is used, and the image forming apparatus 102 of which the use frequency as the scanner is the highest is selected as the installation destination. Here, it is assumed that all the image forming apparatuses 101 to 104 are in a usable status. Accordingly, “Yes” is determined in Step S806, and the process proceeds to Step S808. A case where any of the image forming apparatuses 101 to 104 is not in the usable status will be described later as another example C.

After the installation destinations of the cooperation software are determined, the relay apparatus 110 transmits requests for issuing keys each including a “software ID of corresponding software” and an “apparatus ID of an image forming apparatus to which the software is to be installed” to the activation server 140 in Step S808. In this example, requests for issuing license keys of the software of “software ID: S001” and the apparatus of “apparatus ID: C-002” and the software of “software ID: F003” and the apparatus of “apparatus ID: C-003” are transmitted, and the activation server 140 that has received these requests transmits corresponding license keys to the relay apparatus 110 in Step S809.

The relay apparatus 110 that has received the license keys stores the license keys on the inside thereof and transmits request for downloading the cooperation software as installation targets to the component server 130 in Step S810. In this example, the download requests are transmitted with the software of “software ID: S001” and the software of “software ID: F003” designated in Step S810.

The component server 130 that has received the download requests from the relay apparatus 110 transmits the designated cooperation software to the relay apparatus 110 in Step S811.

The relay apparatus 110 that has received the cooperation software from the component server 130 stores the cooperation software on the inside thereof and transmits requests for installing the software to the image forming apparatuses as the installation targets of the software in combination with the license keys acquired in Step S810 in Step S812. In this example, the software of “software ID: S001” and the license key thereof are transmitted to the image forming apparatus 102 of “apparatus ID: C-002”, and the software of “software ID: F003” and the license key thereof are transmitted to the image forming apparatus 103 of “apparatus ID: C-003”.

The image forming apparatus that has received the request for installing the software performs installation and notifies the relay apparatus 110 of the result thereof in Step S813.

Meanwhile when the reply to the installation request is received from the image forming apparatus, the relay apparatus 110 notifies the management apparatus 120 of the result thereof in Step S814.

Then, the management apparatus 120 receives the results of the requests for installing the software in Step S815 and completes a series of operations.

As above, the installation of the cooperation software in the image forming apparatus managing system 100 according to this embodiment is realized. In this embodiment, the supervisor of the image forming apparatuses is not bothered, and an virtual apparatus according to the operating statuses (use statuses) of the image forming apparatuses 101 to 104 can be optimally built, whereby the management cost of the image forming apparatus managing system 100 can be reduced.

Next, other examples of the image forming apparatus managing system 100 according to this embodiment will be described.

Another Example A

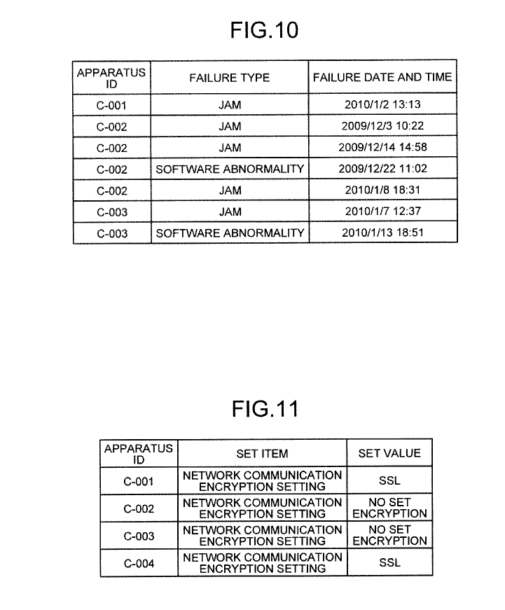

In this example, in Step S805 illustrated in FIGS. 8A and 8B described above, an image forming apparatus as an installation destination is selected on the basis of failure history information of image forming apparatuses instead of the counter information described as the management information in the first example. In this example, when failure history information of each image forming apparatus is received as the management information of the image forming apparatuses 101 to 104, the relay apparatus 110 stores the failure history information on the inside thereof. An example of the table in which the failure history information is stored is illustrated in FIG. 10. In the example illustrated in FIG. 10, a list of apparatus IDs, types of failure, and failure date and time is maintained as the content thereof. In this example, when a user purchases cooperation software, an optimal image forming apparatus to which the cooperation software is to be installed is selected on the basis of the failure history information that is stored on the inside of the relay apparatus 110.

Here, a case will be described in which the cooperation software purchased in the first example is installed. In Step S805 illustrated in FIGS. 8A and 8B, when an installation destination of the software of “software ID: S001” is to be selected from among the image forming apparatuses of “apparatus ID: C-002”, “apparatus ID: C-003”, and “apparatus ID: C-004”, the image forming apparatus 104 of “apparatus ID: C-004” is selected from the table illustrated in FIG. 10 as an image forming apparatus as an installation destination, for example, by using a determination criterion of “selecting an image forming apparatus that has a lowest failure frequency”, thereby realizing this example. Also in this example, the supervisor of the image forming apparatuses 101 to 104 is not bothered, and an virtual apparatus according to the failure history (failure frequencies) of the image forming apparatuses 101 to 104 can be optimally built, whereby the management cost of the image forming apparatus managing system 100 can be reduced.

Another Example B

In this example, in Step S805 illustrated in FIGS. 8A and 8B described above, an image forming apparatus as an installation destination is selected on the basis of software set values of image forming apparatuses instead of the counter information as the management information. When software set values of the image forming apparatuses according to this example are received as the management information of the image forming apparatuses instead of the counter information illustrated in FIG. 7, the relay apparatus 110 stores the information on the inside thereof. An example of the table in which the software set values are stored is illustrated in FIG. 11. In the example illustrated in FIG. 11, a list of apparatus IDs, set items, set values is maintained as the content thereof. In this example, when a user purchases cooperation software, an optimal image forming apparatus to which the cooperation software is to be installed is selected on the basis of the software set value that is stored on the inside of the relay apparatus 110.

Here, a case will be described in which the cooperation software purchased in the first example is installed. In Step S803 illustrated in FIGS. 8A and 8B, the management apparatus 120 transmits a set value that is appropriate to the software requested to be installed to the relay apparatus 110 together with an installation request, and in Step S805 illustrated in FIGS. 8A and 8B, when an installation destination of the software of “software ID: S001” is to be selected from among the image forming apparatuses of “apparatus ID: C-002”, “apparatus ID: C-003”, and “apparatus ID: C-004”, the relay apparatus 110 selects an image forming apparatus that is appropriate to the software set value received in the installation request.

For example, in a case where the network communication encryption setting of the cooperation software to be installed is set to SSL communication, on the basis of the set value (set information) of the software as the management information stored inside the relay apparatus 110, which is represented in the example of the table illustrated in FIG. 11, the information forming apparatus of “apparatus ID: C-004” that coincides with the above-described condition is selected as an image forming apparatus as an installation destination. Also in this example, the supervisor of the image forming apparatuses 101 to 104 is not bothered, and an virtual apparatus according to the operating statuses of the image forming apparatuses 101 to 104 can be optimally built, whereby the management cost of the image forming apparatus managing system 100 can be reduced.

Another Example C

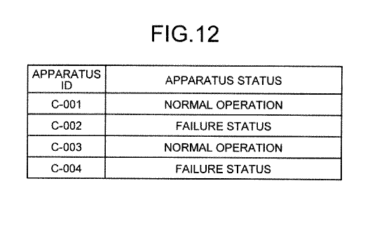

In contrast to the first example, this example is featured (first feature) in that cooperation software can be installed by excluding image forming apparatuses that are currently in a failure status. In order to realize this point, in this example, the image forming apparatuses 101 to 104 transmit not only the counter information as illustrated in FIG. 7 but also failure notifications of the image forming apparatuses 101 to 104 as the management information. When the failure notifications of the image forming apparatuses are additionally received as a part of the management information of the image forming apparatuses 101 to 104, the relay apparatus 110 stores the information (apparatus statuses) on the inside thereof. An example of a table in which the apparatus status is stored is illustrated in FIG. 12. In the example illustrated in FIG. 12, a list of apparatus IDs and the apparatus statuses (normal operation status/failure status) is maintained as the content thereof.

In Step S806 illustrated in FIGS. 8A and 8B, it is determined whether or not the image forming apparatus selected in Step S805 can be currently used, and, in a case where any image forming apparatus is not available to be used (No in Step S806), an image forming apparatus, which is an optimal installation destination of the software, is selected out of currently available image forming apparatuses (in other words, unusable image forming apparatuses are excluded) in Step S807.

Here, a case will be described in which the cooperation software purchased in the first example is installed. In the first example, the image forming apparatuses of “apparatus ID: C-002”, “apparatus ID: C-003”, and “apparatus ID: C-004” can be selected as the installation destination of the software of “software ID: S001”. In this example, however, it can be determined that the image forming apparatuses of “apparatus ID: C-002” and “apparatus ID: C-004” can be determined to be in the failure status on the basis of the information (apparatus statuses) of FIG. 12 that is stored inside the relay apparatus 110. Accordingly, in this example, as the installation destination of the cooperation software, the information forming apparatus of “application ID: C-003” is selected.

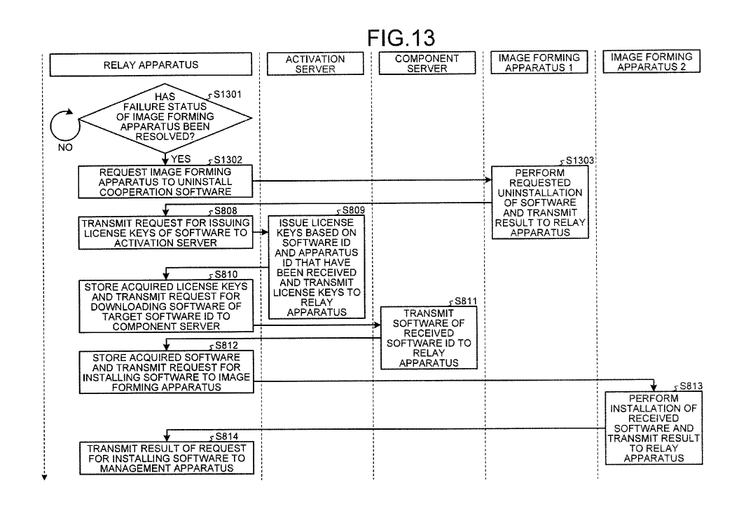

In addition, this example is also featured (second feature) in that, when the image forming apparatus of “apparatus ID: C-002” to be originally selected as the installation destination if not in the failure status is recovered, the cooperation software of “software ID: S001” is uninstalled from the image forming apparatus of “apparatus ID: C-003” for which installation has been completed, and the same software is reinstalled to the image forming apparatus 102 of “apparatus ID: C-002 again. The flow of the process is illustrated in FIG. 13. In FIG. 13, the same step number is assigned to each process that is common to that illustrated in FIGS. 8A and 8B, and the description thereof will not be presented here.

As above, a process until the software of “software ID: S001” to be originally installed to the image forming apparatus 102 of “apparatus ID: C-002” is installed to the image forming apparatus 103 of “apparatus ID: C-003” due to the failure of the image forming apparatus 102 of “apparatus ID: C-002” has been described. In FIG. 13, the flow of the process of uninstalling the cooperation software of “software ID: S001” from the image forming apparatus 103 of “apparatus ID: C-003” for which installation has been completed and reinstalling the same software to the image forming apparatus 102 of “apparatus ID: C-002 again when the image forming apparatus 102 of “apparatus ID: C-002” to be originally selected as the installation destination if not in the failure status is recovered.

The relay apparatus 110 monitors a failure recovery notification transmitted from the image forming apparatus 102 of “apparatus ID: C-002” to which the cooperation software is originally to be installed (No in Step S1301). When the image forming apparatus 102 is recovered from the failure, and the failure recovery notification is received (at this time, “Yes” is determined in Step S1301), the relay apparatus 110 transmits an uninstallation request to the image forming apparatus 103 of “apparatus ID: C-003” to which the cooperation software of “software ID: S001” has been already been installed in Step S1302.

The image forming apparatus 103 of “apparatus ID: C-003” that has received the uninstallation request from the relay apparatus 110 uninstalls the cooperation software of “software ID: S001” and transmits the result thereof to the relay apparatus 110 in Step S1303.

Thereafter, along the flow of the same process as that of Step S808 illustrated in FIGS. 8A and 8B and after that, installation of the cooperation software to an optimal image forming apparatus is realized. In this example, even in a case where the optimal image forming apparatus is in the failure status, the virtual apparatus can be used by using an image forming apparatus as a substitution. In addition, after the image forming apparatus to be originally selected is recovered, the virtual apparatus having the originally optimal configuration can be used.

Another Example D

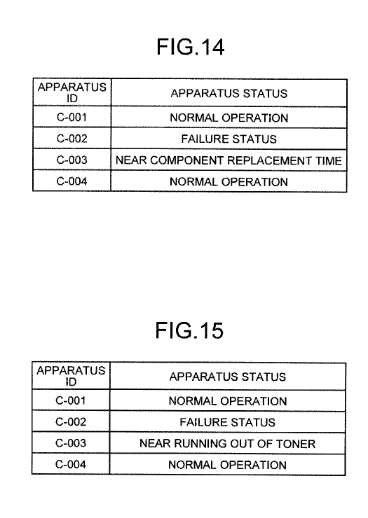

In contrast to the above-described example C, this example is featured in that the cooperation software can be installed by excluding an image forming apparatus of which the component replacement time is near in addition to the image forming apparatuses that are currently in the failure status. Here, a case will be described in which the cooperation software purchased in the first example is installed. In the first example, the image forming apparatuses of “apparatus ID: C-002”, “apparatus ID: C-003”, and “apparatus ID: C-004” can be selected as the installation destination of the software of “software ID: S001”. In this example, however, by excluding an image forming apparatus of which the component replacement time is near out of currently available image forming apparatuses by referring to a table of FIG. 14 in which the apparatus status including information of the component replacement time is stored, the image forming apparatus 104 of “apparatus ID: C-004” can be selected as the installation destination of the cooperation software with the component replacement time reflected on the determination criteria.

In addition, in a case where the image forming apparatus of which the component replacement time is near is the originally optimal installation destination, after the replacement of the component, the cooperation software is uninstalled from the image forming apparatus to which the cooperation software has been already installed, and the cooperation software is reinstalled to the originally optimal installation destination after the replacement of the component. The flow of the process at this time is similar to that of the above-described example C described with reference to FIG. 13, and “after replacement of the component” in this example corresponds to “the recovery from the failure status” in Example C. The relay apparatus 110 receives a component replacement notification instead of the failure recovery notification from the image forming apparatus after the replacement of the component, and the process of Step S1301 illustrated in FIG. 13 and after that is performed. Accordingly, installation of the cooperation software to the optimal image forming apparatus is realized. In this example, a virtual apparatus excluding an image forming apparatus that will be unusable soon due to the life time of the component can be built.

Another Example E

In contrast to the above-described example C, this example is featured in that the cooperation software can be installed by excluding an image forming apparatus of which the replacement time of supplies (for example, running-out of toner) is near in addition to the image forming apparatuses that are currently in the failure status. Here, a case will be described in which the cooperation software purchased in the first example is installed. In the first example, the image forming apparatuses of “apparatus ID: C-002”, “apparatus ID: C-003”, and “apparatus ID: C-004” can be selected as the installation destination of the software of “software ID: S001”. In this example, however, by excluding an image forming apparatus of which the replacement time of supplies is near out of currently available image forming apparatuses by referring to a table of FIG. 15 in which the apparatus status including information of the replacement time of supplies is stored, the image forming apparatus 104 of “apparatus ID: C-004” can be selected as the installation destination of the cooperation software with the replacement time of supplies reflected on the determination criteria.

In addition, in a case where the image forming apparatus of which the replacement time of supplies is near is the originally optimal installation destination, after the replacement of the supplies, the cooperation software is uninstalled from the image forming apparatus to which the cooperation software has been already installed, and the cooperation software is reinstalled to the originally optimal installation destination after the replacement of the supplies. The flow of the process at this time is similar to that of the above-described example C described with reference to FIG. 13, and “after replacement of the supplies” in this example corresponds to “the recovery from the failure status” in Example C. The relay apparatus 110 receives a supply replacement notification instead of the failure recovery notification from the image forming apparatus after the replacement of the supplies, and the process of Step S1301 illustrated in FIG. 13 and after that is performed. Accordingly, installation of the cooperation software to the optimal image forming apparatus is realized. In this example, a virtual apparatus excluding an image forming apparatus that will be unusable soon due to the necessity of the replacement of supplies can be built.

As above, although the embodiment of the invention and other examples thereof have been described, the invention is not limited thereto. Thus, the embodiment and the examples can be changed therein within the scope not departing from the main concept of the invention.

Other Embodiments

A program implementing the function of a relay apparatus 110 according to this embodiment is provided as being built in a non-volatile storage medium such as the HDD 203 of the relay apparatus 110 as an information processing apparatus in advance or is provided as being recorded on a computer-readable medium such as a CD-ROM, a flexible disk (FD), a CD-R, or a digital versatile disk (DVD) in an installable format or an executable format.

Alternatively, the above-described program may be configured to be stored in a computer connected to a network such as the Internet and be provided or distributed as being downloaded through a network.

According to the present invention, since cooperation software is automatically installed to an optimal image processing apparatus out of a plurality of image processing apparatuses that can be used as virtual apparatuses on the basis of the operating status of each image processing apparatus, a supervisor of the image processing apparatuses is not bothered, and a virtual apparatus adapted to the operating status of the image processing apparatuses of a customer can be optimally build in an easy manner, thereby an advantage that the management cost for managing the image processing apparatuses can be reduced is acquired.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an image processing apparatus managing unit that collects management information of a plurality of image processing apparatuses and, in accordance with a request for installing software that is transmitted from the outside, downloads the software to be installed to the image processing apparatus from the outside, acquires license information of the software from the outside, and installs the software to the image processing apparatus,
wherein the image processing apparatus managing unit installs cooperation software to an optimal image processing apparatus on the basis of the collected management information in a case where the software requested to be installed is the cooperation software that operates the plurality of image processing apparatuses in a cooperative manner.

2. The information processing apparatus according to claim 1, wherein the image processing apparatus managing unit collects failure history information of the plurality of image processing apparatuses as the management information and, when the cooperation software is to be installed, installs the cooperation software to an optimal image processing apparatus on the basis of the failure history information.

3. The information processing apparatus according to claim 1, wherein the image processing apparatus managing unit collects set information of software of the plurality of image processing apparatuses as the management information and, when the cooperation software is to be installed, installs the cooperation software to an optimal image processing apparatus on the basis of the set information.

4. The information processing apparatus according to claim 1,
wherein the image processing apparatus managing unit manages failure statuses of the plurality of image processing apparatuses as the management information,
wherein, when the cooperation software is to be installed in response to the request for installing software that is transmitted from the outside, the image processing apparatus managing unit installs the cooperation software to an optimal image forming apparatus out of the image forming apparatuses that are in normal operations, and
wherein, in a case where the image forming apparatus that is in a failure status is the originally optimal installation destination, after the failure is recovered, the image processing apparatus managing unit uninstalls the cooperation software from another image forming apparatus to which the cooperation software has already been installed and reinstalls the cooperation software to the recovered image processing apparatus.

5. The information processing apparatus according to claim 4,
wherein the image processing apparatus managing unit additionally collects information of component replacement time from the plurality of image processing apparatuses as the management information,
wherein, when the cooperation software is to be installed in response to the request for installing software that is transmitted from the outside, the image processing apparatus managing unit installs the cooperation software to an optimal image forming apparatus out of the image forming apparatuses of which the component replacement time is not near, and
wherein, in a case where the image forming apparatus of which the component replacement time is near is the originally optimal installation destination, after the component is replaced, the image processing apparatus managing unit uninstalls the cooperation software from another image forming apparatus to which the cooperation software has already been installed and reinstalls the cooperation software to the image forming apparatus of which the component has been replaced.

6. The information processing apparatus according to claim 4,
wherein the image processing apparatus managing unit additionally collects information of statuses of supplies from the plurality of image processing apparatuses as the management information,
wherein, when the cooperation software is to be installed in response to the request for installing software that is transmitted from the outside, the image processing apparatus managing unit installs the cooperation software to an optimal image forming apparatus out of the image forming apparatuses of which the replacement time of the supplies is not near, and
wherein, in a case where the image forming apparatus of which the replacement time of the supplies is near is the originally optimal installation destination, after the supplies are replaced, the image processing apparatus managing unit uninstalls the cooperation software from another image forming apparatus to which the cooperation software has already been installed and reinstalls the cooperation software to the image forming apparatus of which the supplies have been replaced.

7. An image processing apparatus managing system comprising:
a software selling unit that accepts a user's purchase of software and transmits purchase information that includes information on the purchased software and information on a user site of the user purchasing the software;
a user site managing unit that manages image processing apparatuses located on the user site side, receives the purchase information from the software selling unit, and performs a request for installing the purchased software on the user site side on the basis of the purchase information;
a software providing unit that provides the purchased software;
a license providing unit that provides license information of the purchased software;
a plurality of image processing apparatuses; and
an image processing apparatus managing unit that collects management information of the plurality of image processing apparatuses, in response to the request for installing the software that is transmitted from the user site managing unit, downloads the purchased software from the software providing unit, acquires the license information of the software from the license providing unit, and installs the acquired software to the image processing apparatus,
wherein the image processing apparatus managing unit installs cooperation software to an optimal image processing apparatus on the basis of the collected management information in a case where the software requested to be installed is the cooperation software that operates the plurality of image processing apparatuses in a cooperative manner.

8. A method of processing information using information processing apparatuses, the method comprising:
collecting management information of a plurality of image processing apparatuses and, in accordance with a request for installing software that is transmitted from the outside, downloading the software to be installed to the image processing apparatus from the outside, acquiring license information of the software from the outside, and installing the software to the image processing apparatus, using an image processing apparatus managing unit,
wherein, in the collecting of management information, downloading of the software, acquiring of license information, and installing of the software, cooperation software is installed to an optimal image processing apparatus on the basis of the collected management information in a case where the software requested to be installed is the cooperation software that operates the plurality of image processing apparatuses in a cooperative manner.
